(19) United States
(12) Patent Application Publication
(10) Pub. No.: US 2026/0205503 A1
(43) Pub. Date: Jul. 16, 2026

(54) APPARATUS AND METHOD FOR AUGMENTING A PRE-EXISTING TIP AND RING-BASED COMMUNICATION SYSTEM WITH VIDEO CAPABILITY

(71) Applicants: Laurence Fish, San Diego, CA (US); Jefrrey Gilbert, Highland Park, IL (US)

(72) Inventors: Laurence Fish, San Diego, CA (US); Jefrrey Gilbert, Highland Park, IL (US)

(21) Appl. No.: 19/441,150

(22) Filed: Jan. 6, 2026

Related U.S. Application Data
(60) Provisional application No. 63/746,177, filed on Jan. 16, 2025.

(51) Int. Cl. H04L 65/1089

(52) U.S. Cl. CPC H04L 65/1089

(57) ABSTRACT

An interface apparatus for providing video-enhanced communication for tip and ring-based communication systems. The apparatus interfaces with existing tip and ring communication lines to detect call initiation, collect dialed digits, and query a video-enabled database independent of the tip and ring system's directory to determine routing. Users register for video capability through a mobile application, creating an opt-in system maintaining backward compatibility for non-registered users. The apparatus comprises a telephone adapter for tip and ring interface and digit collection, a processor for determining call routing between video-enhanced and PSTN modes based on database query results, a video feed generator for streaming video, and a controller for directing audio and video streams to a media server. The apparatus passively monitors the pre-existing system without replacing it, allowing independent operation while adding video capability as an overlay for registered users.

### TECHNICAL FIELD

The present invention relates to communication interface devices, specifically to an apparatus that interfaces with tip and ring communication lines to provide video-enhanced communication capabilities.

### BACKGROUND

Many existing communication systems use Public switched telephone network (PSTN) or Voice over internet protocol (VoIP) technology to connect parties through audio-only communication via tip and ring lines. These systems transmit audio signals over tip and ring communication infrastructure and allow responses through the same lines using DTMF tones or audio signals.

While video communication devices exist that interface with simple two-wire systems (such as video doorbells that connect to existing doorbell wiring), these solutions are designed for single-endpoint applications serving a single location rather than multi-user communication networks. Such single-endpoint devices do not provide digit-based routing to multiple destinations, do not maintain separate databases mapping digit sequences to different users, and do not support selective user registration allowing some users to receive video-enhanced calls while others continue with audio-only communication. Similarly, while video conferencing platforms exist that integrate with telephone systems, these platforms typically replace the existing communication infrastructure and serve as the primary communication system rather than augmenting a pre-existing audio-only system. There remains a need for a solution that can add video capability to existing multi-user tip and ring communication networks through passive monitoring and augmentation, without requiring system replacement, while enabling selective user opt-in through mobile application registration rather than mandating system-wide deployment.

Analog Telephone Adapters (ATAs) and VoIP gateway devices exist that interface with tip and ring communication lines to convert analog telephone signals to digital VoIP protocols. However, these devices typically function as replacement technologies that convert the existing tip and ring system to a different communication protocol (such as SIP or H.323), rather than passively monitoring and augmenting the existing system while preserving its original functionality. ATAs generally do not maintain separate databases mapping dialed digit sequences to user-specific video preferences, do not support selective user registration where individual users can opt into video-enhanced communication while others continue with audio-only calls, and do not provide an overlay architecture that allows the pre-existing communication system to continue operating independently for non-registered users. Furthermore, existing ATAs and VoIP gateways focus on protocol conversion and do not integrate video capability with intelligent routing based on user registration status and preferences stored in a database separate from the tip and ring system's directory.

There is a need for an interface apparatus that connects to existing tip and ring communication systems, collects dialed digits or call initiation signals, and routes “calls” with integrated video, while maintaining backward compatibility with standard PSTN calling when needed, wherein the “calls” are WebRTC or similar real-time communication protocol calls transmitted to a smartphone application.

### SUMMARY

The present invention provides an interface apparatus for connecting to audio-based communication systems using tip and ring lines to enable video-enhanced communication. The apparatus interfaces with existing tip and ring infrastructure, detects call initiation, collects dialed digits, and routes “calls” with simultaneous video and audio.

The apparatus comprises: (a) a telephone adapter configured to interface with tip/ring communication lines, detect call initiation signals, and collect dialed digits transmitted over the tip/ring lines; (b) a video feed generator configured to stream live video; (c) a processor configured to determine call routing based on the collected digits and a database accessible by the apparatus of video-enabled destinations (hereinafter ‘video-enabled database’); and (d) a controller configured to direct the audio from the tip and ring interface and the streaming video to a media server configured to combine the audio and video to generate a composite audio and video stream for transmission to a receiving device.

The apparatus does not initiate calls but operates as a passive interface responsive to signals on the tip and ring lines. The apparatus monitors the tip and ring interface and responds to call initiation signals and dialed digits transmitted by the tip and ring communication system, functioning as a slave to the tip and ring interface.

The apparatus has access to a video-enabled database that is separate and independent from any directory in the tip and ring communication system. The database maps dialed digit sequences to users who have registered through a mobile application and enabled video calling. When collected digits match a video-enabled destination, calls are routed according to user preferences; otherwise, calls default to a PSTN fallback mode.

The apparatus supports multiple calling modes: (a) video-enhanced mode, where audio and video are transmitted to a mobile application on the recipient's device; and (b) PSTN fallback mode, where the call is routed through traditional telephone networks when video calling is unavailable, disabled, backend or database malfunction, or when the dialed digits do not match a video-enabled destination.

The invention also provides a method comprising: interfacing with the tip and ring communication lines, detecting call initiation, collecting dialed digits from the tip and ring interface, querying a video-enabled database to determine if digits correspond to a registered video-enabled user, determining appropriate call routing (video-enhanced or PSTN) based on registration status and user preferences, streaming video, combining the video with audio from the tip and ring lines, and transmitting the composite audio and video stream to a receiving device.

### BRIEF DESCRIPTION OF THE DRAWINGS

The accompanying drawings illustrate embodiments of the invention:

FIG. 1 illustrates a block diagram of the interface apparatus connected to a tip and ring communication system, according to an embodiment of the present invention.

FIG. 2 illustrates an environment of the telephone adapter component configured to interface with tip and ring communication lines, according to an embodiment of the present invention.

FIG. 3 illustrates the digit collection and call routing logic, according to an embodiment of the present invention.

FIG. 4 illustrates video-enhanced call flow from caller to recipient device, according to an embodiment of the present invention.

FIG. 5 illustrates PSTN fallback call flow, according to an embodiment of the present invention.

FIG. 6 illustrates the method for providing video-enhanced communication through tip/ring interface, according to an embodiment of the present invention.

### DETAILED DESCRIPTION

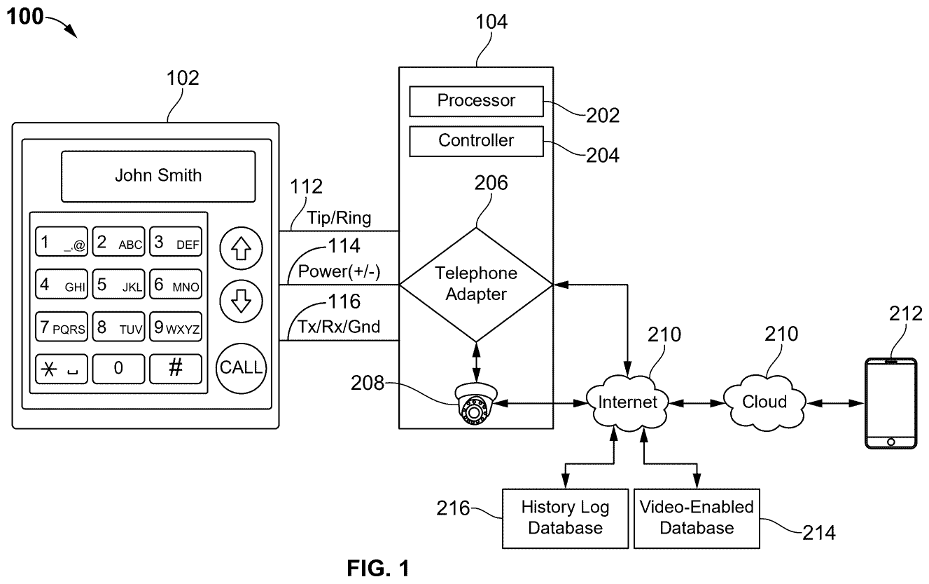

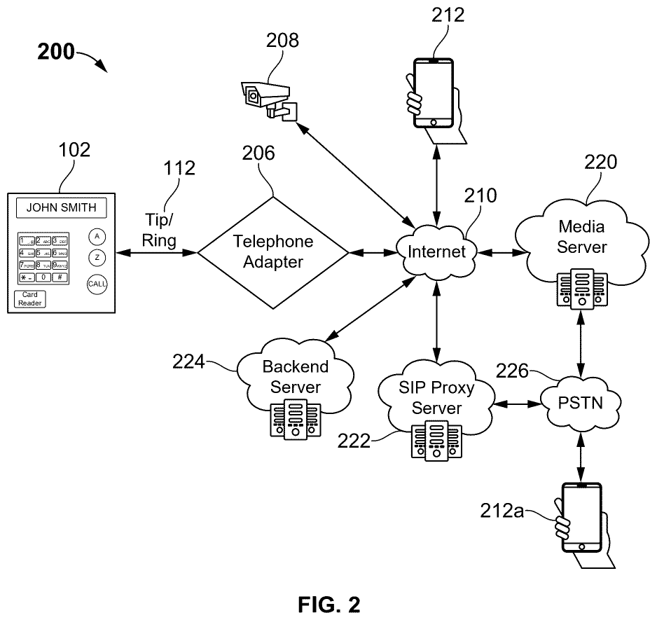

The present invention provides an interface apparatus that connects to existing audio-based communication systems using tip and ring lines to enable video-enhanced communication without requiring replacement of the existing infrastructure. The apparatus interfaces with tip and ring communication lines to detect calls, collect dialed digits, and route calls appropriately. In this specification, “user device” and “recipient device” and “receiving device” are used interchangeably. Further, “user”, “recipient”, and “receiver” are used interchangeably. FIG. 1 illustrates a block diagram 100 of an interface apparatus 104 connected to a tip and ring communication system, according to an embodiment of the present invention. FIG. 2 illustrates an environment 200 of the telephone adapter 206 component configured to interface with tip and ring communication lines, according to an embodiment of the present invention. Referring to FIG. 1 and FIG. 2, the apparatus 104 comprises, a telephone adapter 206, a processor, 202, a controller 204, and a video feed generator 208.

### Tip and Ring Interface and Digit Collection

The apparatus 104 comprises a telephone adapter 206 configured to interface with the tip and ring communication lines 112 of an existing communication system 104. The telephone adapter 206 monitors the tip and ring lines 112 to detect off-hook conditions indicating call initiation. Upon detecting call initiation, the telephone adapter 206 collects dialed digits transmitted as Dual-Tone-Multi-Frequency (DTMF) tones or pulse dialing signals over the tip and ring line 112.

The telephone adapter 206 maintains the electrical characteristics required for proper tip and ring operation, including appropriate impedance matching and DC loop current characteristics. This ensures compatibility with existing communication systems without requiring modifications to the installed equipment. The collected digits are passed to the processor 202 for call routing determination. The processor 202 references a database 214 of video-enabled destinations mapping dialed digit sequences to specific users who have registered for video-enhanced communication.

### Audio Processing and Digitization

The telephone adapter 206 comprises an audio interface configured to extract analog audio signals from the tip and ring communication lines and convert them to digital format suitable for transmission to a media server 220. The audio interface performs several critical functions: impedance matching with the tip and ring lines, analog-to-digital conversion, audio encoding, and Real-time Transport Protocol (RTP) packet formatting for network transmission.

In the preferred embodiment, the audio interface includes an analog front-end circuit with impedance matching (typically 600 ohms to match standard telephone line impedance) and a codec integrated circuit for analog-to-digital conversion. Suitable codec Integrated circuits (ICs) include the Texas Instruments PCM2900, Cirrus Logic CS4270, or similar telephone line interface chips. The suitable codec ICs provide: (a) analog-to-digital conversion at sampling rates of 8 kHz (narrowband), 16 kHz (wideband), or 48 kHz (ultra-wideband); (b) 16-bit resolution or higher; (c) line echo cancellation; (d) automatic gain control; and (e) Dual-tone-multi-frequency (DTMF) detection capability.

The digitized audio is processed using PJSIP (PJSUA2 API), an open-source Session initiation protocol (SIP) and media stack that handles: (a) audio codec negotiation supporting G.711, G.722, Opus, and other standard codecs; (b) RTP packet formatting and transmission according to RFC 3550; (c) jitter buffering and packet loss concealment; (d) echo cancellation and noise suppression; and (e) media stream routing to the media server 220. PJSIP provides a comprehensive framework for handling real-time audio communication and integrates seamlessly with SIP-based communication infrastructure.

In one embodiment, the PJSIP stack is configured to encode audio using the Opus codec (RFC 6716) at 16 kHz sampling rate and 32 kbps bitrate, providing a balance between audio quality and bandwidth efficiency. Alternative configurations may use: (a) G.711 (8 kHz, 64 kbps) for maximum compatibility with legacy PSTN systems; (b) G.722 (16 kHz, 64 kbps) for wideband audio quality; or (c) Opus at higher bitrates (48-64 kbps) for premium audio quality when bandwidth is not constrained. The codec selection may be dynamically adjusted based on available network bandwidth and quality of service requirements.

The PJSIP stack encapsulates the encoded audio into RTP (Real-time Transport Protocol, RFC 3550) packets with timestamps synchronized to a common clock reference, enabling proper audio-video synchronization at the media server 220. Each RTP packet includes: (a) a sequence number for packet ordering and loss detection; (b) a timestamp derived from the sampling clock for synchronization; (c) a payload type identifier indicating the codec used; and (d) a synchronization source identifier (SSRC) uniquely identifying the audio stream. This RTP packaging ensures that audio can be properly synchronized with video streams at the media server, even when the two streams traverse different network paths with varying delays.

The telephone adapter 206 may be implemented using a system-on-chip (SoC) or embedded processor running Linux (such as Raspberry Pi, BeagleBone, or similar embedded computing platforms) with the PJSIP library compiled and configured for SIP user agent functionality. In one embodiment, the telephone adapter 206 comprises a Raspberry Pi 4 Model B with a USB audio interface dongle providing analog input and output connectivity to the tip and ring lines. Alternative embodiments may use dedicated telecommunications hardware such as VoIP gateway appliances, custom-designed circuit boards with integrated codec chips, or software running on general-purpose computing hardware with appropriate audio interface cards.

Alternative embodiments may use other SIP stacks (such as Asterisk PBX, FreeSWITCH, or proprietary SIP implementations) or direct audio capture and encoding without a SIP layer, depending on system architecture requirements. For implementations not using SIP, the audio interface may directly capture audio samples, encode them using a selected codec, and transmit RTP packets to the media server 220 without SIP signaling overhead. Such direct implementations may be preferred in closed systems where SIP interoperability is not required.

The telephone adapter's 206 DTMF detection capability may be implemented in hardware (via the codec IC's built-in DTMF decoder) or in software (via PJSIP's DTMF detection algorithms or dedicated DSP processing). When a DTMF tone is detected on the tip and ring line 112, the system decodes the tone into its corresponding digit (0-9, *, #, or A-D) and passes the digit to the processor for accumulation into the complete dialed digit sequence.

In one embodiment, PJSIP is configured to use RFC 2833 (RTP Payload for DTMF Digits, Telephony Tones, and Telephony Signals) for reliable digit transmission, wherein DTMF digits detected in the audio stream are transmitted as discrete RTP events separate from the audio payload. This method provides more reliable digit detection than in-band audio DTMF detection, particularly over networks with audio compression or packet loss. Alternative embodiments may rely on in-band audio DTMF detection for compatibility with systems that do not support RFC 2833, using digital signal processing algorithms to detect the dual-tone frequencies that comprise each DTMF digit.

When a recipient responds via the mobile application, the return audio path operates as follows: the recipient's voice is captured by the mobile device's microphone, encoded by the mobile application using the same codec negotiated for the outbound stream (typically Opus, G.711, or G.722), and transmitted as RTP packets to the media server 220. The codec negotiation ensures that both the outbound and return audio paths use compatible encoding schemes, facilitating efficient audio processing and minimal latency.

The media server 220 forwards the recipient's audio stream to the apparatus 104, where the PJSIP stack receives the RTP packets, performs jitter buffering to compensate for network delay variations, detects and conceals packet loss, and decodes the audio into digital audio samples. The decoded audio samples are then passed to a digital-to-analog converter (DAC) circuit (not shown) for conversion back to analog signals suitable for transmission over the tip and ring line 112.

The DAC circuit converts the digital audio to analog signals with appropriate voltage levels and impedance matching for the tip and ring lines 112. Standard telephone line interfaces typically operate at signal levels between −10 dBm and 0 dBm with 600-ohm impedance. The analog audio is then transmitted over the tip and ring line 112 to the pre-existing communication system 102, where it is delivered to the original caller through the existing audio infrastructure. In the preferred embodiment, the same codec IC used for analog-to-digital conversion also provides digital-to-analog conversion for the return path, ensuring symmetric audio processing, consistent impedance matching, and simplified hardware design.

The bidirectional audio path maintains full-duplex communication, meaning that audio can flow simultaneously in both directions without interruption. The PJSIP stack and audio interface hardware include echo cancellation algorithms that prevent acoustic feedback and line echo, which can occur when audio from a loudspeaker is picked up by a microphone or when impedance mismatches cause signal reflections on the tip and ring line 112. The echo cancellation typically employs adaptive filters that model the acoustic environment and subtract the estimated echo from the transmitted signal, resulting in clear bidirectional communication.

In certain embodiments, the audio interface may include additional signal processing capabilities such as: (a) automatic gain control to normalize audio levels across different callers and varying line conditions; (b) noise reduction to filter background noise and improve speech intelligibility; (c) voice activity detection to identify periods of speech versus silence, enabling bandwidth optimization; and (d) comfort noise generation to provide natural-sounding background noise during silence periods, preventing the unsettling effect of complete silence in digital communication systems.

### Call Routing Logic

The collected digits are passed to the processor 202 for call routing determination. The processor 202 queries the video-enabled database 214 using the collected digit sequence to determine if it corresponds to a registered video-enabled user.

If the collected digits match a video-enabled destination in the video-enabled database 214, the processor 202 determines call routing based on: (a) the matched user's preferences indicating whether video calling is enabled; (b) device availability and capabilities of the user's receiving device; and (c) current system status including network connectivity.

If the collected digits do not match any video-enabled destination in the video-enabled database 214, the processor 202 defaults to the PSTN fallback mode, routing the call through traditional telephone networks. This ensures that calls to non-registered users can still be completed using the tip and ring system's own directory and routing mechanisms.

For video-enabled destinations, the routing determination selects between: (a) video-enhanced mode, where the call is routed to a mobile application with simultaneous audio and video; or (b) PSTN fallback mode, where the call is routed through traditional telephone networks as an audio-only call.

In video-enhanced mode, the processor triggers a video feed generator to stream live video. The controller 204 receives the audio signal from the tip and ring interface and the video feed from the video feed generator 208. The controller 204directs the audio and video streams to the media server 220 that combines them to generate a combined output for transmission to the recipient's device 212.

In PSTN fallback mode, the apparatus 104 routes the call through a PSTN gateway or SIP trunk to reach the recipient's telephone number as a standard voice call. This mode is activated when: (a) the collected digits do not match a video-enabled destination; (b) the registered user has disabled video calling; (c) the user's device is offline or unreachable; or (d) network conditions prevent video transmission.

### Video Feed Generation and Stream Combining

The apparatus 104 comprises the video feed generator 208 which is configured to capture and stream live video when video-enhanced mode is selected. The video feed generator 208 is triggered automatically upon detection of call initiation on the tip and ring line 112, ensuring that video streaming begins immediately when a call is initiated. The video feed is combined with audio from the tip and ring interface by the media server 220 that synchronizes and multiplexes the two streams into a composite audio and video stream suitable for delivery to the recipient's mobile device 212.

The video feed generator 208 comprises one or more cameras positioned at the calling location to capture video of the area or person initiating the call. The cameras may be: (a) USB cameras connected to the apparatus's computing platform; (b) IP cameras with network connectivity; (c) cameras integrated into custom hardware; or (d) mobile device cameras in implementations where the apparatus is implemented on a smartphone or tablet. In one embodiment, the video feed generator 208 uses a standard USB webcam (such as Logitech C920 or similar) connected to a Raspberry Pi or other embedded computing platform running the apparatus software.

The captured video is encoded using a video compression codec to reduce bandwidth requirements for transmission. Suitable video codecs include H.264 (also known as AVC or MPEG-4 Part 10), H.265 (also known as HEVC), VP8, VP9, or AV1. In the preferred embodiment, video is encoded using H.264 with a Main Profile at 720p resolution (1280[0045]×[0046] 720 pixels) and 30 frames per second, providing a good balance between video quality and bandwidth consumption. The encoded video bitrate may range from 500 kbps to 2 Mbps depending on available network bandwidth and desired quality. Alternative embodiments may encode video at different resolutions (480p, 1080p, or 4K) or frame rates (15 fps, 24 fps, 60 fps) depending on application requirements.

In the preferred embodiment, the media server 220 is implemented using LiveKit, an open-source WebRTC media server designed for real-time audio and video communication. LiveKit provides a scalable Selective Forwarding Unit (SFU) architecture that efficiently routes media streams between participants without transcoding, minimizing latency and server resource consumption. LiveKit supports the WebRTC protocol stack including: (a) RTP (Real-time Transport Protocol) and RTCP (RTP Control Protocol) for media transport; (b) SRTP (Secure Real-time Transport Protocol) for encrypted media transmission; (c) ICE (Interactive Connectivity Establishment) for NAT traversal; (d) STUN (Session Traversal Utilities for NAT) and TURN (Traversal Using Relays around NAT) for connectivity in restrictive network environments; and (e) DTLS (Datagram Transport Layer Security) for secure key exchange.

LiveKit operates as an SFU, meaning it receives media streams from publishers (in this case, the apparatus publishing audio and video) and forwards those streams to subscribers (the mobile application). Unlike an MCU (Multipoint Control Unit) which decodes, mixes, and re-encodes all streams, an SFU simply forwards packets, resulting in lower latency and reduced server computational requirements. The SFU architecture allows each subscriber to receive different quality levels through simulcast (where multiple resolutions of the same video are published) or through adaptive bitrate control, enabling the mobile application to select an appropriate quality level based on its network conditions and device capabilities.

Alternative embodiments may use other WebRTC media servers such as Janus Gateway, Mediasoup, Jitsi Videobridge, Kurento Media Server, or proprietary media server implementations. Non-WebRTC embodiments may use other real-time streaming protocols such as RTMP (Real-Time Messaging Protocol) with servers like Nginx-RTMP or Wowza Streaming Engine, or HLS (HTTP Live Streaming) with adaptive bitrate streaming. The choice of media server and protocol depends on factors including latency requirements, scalability needs, device compatibility, and existing infrastructure.

The controller 204 of the apparatus 104 is responsible for directing both the audio stream from the telephone adapter 206 and the video stream from the video feed generator 208 to the LiveKit media server 220. In the preferred embodiment using LiveKit, the controller 204 establishes a WebRTC peer connection to the LiveKit server and publishes two tracks: an audio track containing the encoded audio from the tip and ring line 112 (as processed by PJSIP and encoded with Opus, G.711, or G.722), and a video track containing the encoded video from the camera (encoded with H.264 or another video codec).

LiveKit handles the synchronization of audio and video streams using RTP timestamps. Both the audio and video encoders generate RTP packets with timestamps derived from their respective sampling clocks. The LiveKit server 220 and the receiving mobile application use these timestamps to synchronize playback, ensuring that audio and video remain aligned (lip-sync) even when the streams experience different network delays or packet loss patterns. The synchronization mechanism typically maintains audio-video alignment within 100-200 milliseconds, which is imperceptible to human observers.

The combining of audio and video into a composite stream is achieved through the WebRTC protocol's multiplexing capabilities. In WebRTC, multiple media tracks (audio and video) are multiplexed into a single transport connection using the RTP protocol with different payload types and SSRCs (Synchronization Source identifiers) to distinguish between tracks. The LiveKit server 220 maintains this multiplexing when forwarding streams to subscribers, delivering both audio and video tracks within a single WebRTC peer connection to the mobile application. This multiplexed approach simplifies NAT traversal (only one ICE negotiation is needed) and reduces connection setup time compared to separate connections for audio and video.

The mobile application connects to the LiveKit media server 220 to retrieve the composite audio and video stream. When the apparatus 104 initiates a video-enhanced call, the controller 204 creates a LiveKit room (a virtual conference space) and publishes the audio and video tracks to that room. A Django backend or backend server 224, having determined that the call should be routed in video-enhanced mode to a registered user, sends a push notification to the recipient's mobile device 212 containing: (a) a LiveKit server URL; (b) a room name or identifier; (c) an access token for authentication; and (d) metadata about the caller.

Upon receiving the push notification, the mobile application presents an incoming call interface to the user. If the user accepts the call, the mobile application uses a LiveKit client SDK (Software development kit) available for iOS, Android, React Native, Flutter, and web browsers) to connect to the LiveKit server 220 using the provided room name and access token. The LiveKit client SDK performs WebRTC signaling (using WebSocket connections to the LiveKit server), ICE negotiation for NAT traversal, and DTLS key exchange for encryption. Once the WebRTC peer connection is established, the mobile application subscribes to the audio and video tracks being published by the apparatus 104 and begins receiving and rendering the composite stream.

LiveKit uses JWT (JSON Web Token) access tokens to authenticate and authorize participants. When creating a LiveKit room for a call, the apparatus 104 (or more typically, the Django backend 224) generates a JWT token signed with a secret key that grants the apparatus 104 permission to publish audio and video tracks to a specific room. A separate JWT token is generated for the recipient, granting permission to subscribe to (but not publish) tracks in that room. These tokens have configurable expiration times and can include additional metadata or permissions. The JWT-based security model ensures that only authorized participants can join rooms and prevents unauthorized access to call streams.

LiveKit includes integrated TURN (Traversal Using Relays around NAT) server functionality to handle NAT traversal in challenging network environments. In most cases, WebRTC can establish direct peer-to-server connections using STUN (Session Traversal Utilities for NAT) to discover public IP addresses and ports. However, in restrictive network environments with symmetric NATs or corporate firewalls, direct connections may not be possible. In such cases, the TURN server acts as a relay, forwarding media packets between the apparatus 104 and the mobile application. While TURN relaying adds latency and consumes server bandwidth, it ensures connectivity even in the most restrictive networks, typically achieving connection success rates above 95%.

LiveKit is designed for horizontal scalability, allowing multiple LiveKit servers instances to be deployed in a cluster to handle large numbers of concurrent calls. In a clustered deployment, a Redis database (not shown) is used to coordinate state between LiveKit instances, enabling features such as cross-instance room joining and load balancing. For high-availability deployments, LiveKit instances can be distributed across multiple geographic regions with automatic failover. Alternative embodiments may deploy LiveKit in cloud environments such as AWS, Google Cloud, or Azure using managed Kubernetes services for automatic scaling based on load.

The LiveKit provides extensive quality monitoring and adaptive bitrate control mechanisms. The server tracks quality metrics including: (a) packet loss rates; (b) round-trip time (latency); (c) jitter (variation in packet arrival times); and (d) available bandwidth estimates. Based on these metrics, the LiveKit can signal to publishers (the apparatus) to adjust encoding bitrates, switch between simulcast layers, or temporarily disable video while maintaining audio in extremely poor network conditions. The mobile application receives quality statistics and can display network quality indicators to users or automatically adjust rendering quality to maintain smooth playback.

The LiveKit supports server-side recording of calls for archival, compliance, or quality assurance purposes. When recording is enabled, the LiveKit can capture the audio and video streams and save them to files in formats such as MP4, WebM, or separate audio (Opus/AAC) and video (H.264/VP8) files. The recordings can be stored locally on the LiveKit server or uploaded to cloud storage services such as Amazon S3, Google Cloud Storage, or Azure Blob Storage. The LiveKit also provides webhooks that notify the Django backend 224 of call events (room created, participant joined, participant left, recording completed), enabling integration with call logging and analytics systems.

In certain embodiments, the apparatus 104 operates in a low-bandwidth mode where the video feed generator 208 captures and transmits still images at configurable intervals (e.g., every 2-5 seconds) rather than continuous video streaming. This mode significantly reduces bandwidth requirements while maintaining visual communication capability. In low-bandwidth mode, the video feed generator 208 captures still frames from the camera, encodes them as JPEG or WebP images, and transmits them either: (a) as very low frame rate video (1-5 fps) through the standard LiveKit video track; or (b) as data messages through LiveKit's data channel API. The mobile application displays these still images, updating the display when new frames arrive. This mode is particularly useful for deployments with limited network bandwidth or when video quality is less critical than preserving audio quality.

In embodiments with multiple cameras positioned at different viewing angles, the apparatus 104 can publish multiple video tracks to the LiveKit room, each representing a different camera view. LiveKit's track naming and metadata capabilities allow each video track to be labeled with information such as camera position (e.g., ‘camera_entrance’, ‘camera_desk’, ‘camera_overview’). The mobile application can then subscribe to all available video tracks and provide a user interface allowing the recipient to select which camera view to display or to display multiple views simultaneously in a picture-in-picture or split-screen layout. The ability to switch between camera views gives recipients more context and control over what they see during the call.

### Recipient Response and Signal Transmission

The recipient receives the call on their device 212 with simultaneous audio and video. The recipient can respond with voice communication transmitted back through the apparatus 104. The apparatus 104 converts the recipient's voice into appropriate audio signals and transmits them back over the tip and ring line 112 to the originating communication system 102.

To send control signals, the recipient activates a control in the application. The apparatus 104 generates an appropriate signal, which may be: (a) a DTMF tone sequence transmitted over the tip and ring line 112; (b) a specific audio tone pattern; or (c) a DC voltage pulse, depending on the receiving system's requirements.

The apparatus 104 maintains compatibility with the existing system's signaling mechanisms, ensuring that control functions operate identically to the original audio-only system while adding video capability.

### Video-Enabled Database

The apparatus 104 has access to a video-enabled database 214 that is separate from and independent of any directory maintained by the pre-existing tip and ring communication system 102. The video-enabled database 214 stores mappings between dialed digit sequences and users who have registered for video-enhanced communication, along with user preferences, device tokens, and call routing configurations. This separation ensures that video capability can be added to the existing system 102 without requiring modifications to the pre-existing system's infrastructure or directory services.

In the preferred embodiment, the video-enabled database 214 is implemented using PostgreSQL, an open-source relational database management system known for its reliability, data integrity, and standards compliance. PostgreSQL provides ACID (Atomicity, Consistency, Isolation, Durability) transaction guarantees, ensuring that database operations are performed reliably even under concurrent access or system failures. Alternative embodiments may use other relational database systems such as MySQL, MariaDB, Microsoft SQL Server, or Oracle Database, or may use NoSQL database systems such as MongoDB, Redis, or Cassandra depending on scalability requirements and data access patterns.

The database 214 is accessed through a Django web framework application that provides: (a) an object-relational mapping (ORM) layer that abstracts database operations into Python objects; (b) a RESTful API for communication with the mobile application and the apparatus 104; (c) user authentication and authorization mechanisms; (d) administrative interfaces for system management; and (e) data validation and sanitization to ensure database integrity. Django is an open-source Python web framework that follows the model-view-template (MVT) architectural pattern and provides built-in security features including protection against structured query language (SQL) injection, cross-site scripting (XSS), cross-site request forgery (CSRF), and clickjacking attacks.

The video-enabled database 214 comprises several tables (or collections in NoSQL implementations) with defined schemas. A primary table stores user registration information including fields for: (a) a unique user identifier; (b) the dialed digit sequence assigned to the user; (c) a device token for push notifications to the mobile application; (d) user preferences indicating whether video calling is enabled or disabled; (e) alternative contact numbers for PSTN fallback; (f) registration timestamp; and (g) last active timestamp. Additional tables may store call history logs, user authentication credentials, device information, and system configuration parameters.

In one embodiment using PostgreSQL with Django Object-Relational Mapping (ORM), the database schema is defined using Django models. A UserRegistration model defines the structure for storing user data with fields corresponding to the database columns. For example, the digit_sequence field is defined as a CharField with appropriate maximum length and uniqueness constraints, ensuring that each digit sequence maps to only one registered user. The video_enabled field is defined as a BooleanField indicating the user's preference for video calling. The device_token field stores the unique identifier for the user's mobile device 212, enabling push notifications when calls are initiated.

When the processor 202 receives a collected digit sequence from the telephone adapter 206, it queries the video-enabled database 214 to determine if the digit sequence corresponds to a registered user. Using Django ORM, the query is performed by calling a method such as UserRegistration.objects.filter(digit_sequence=collected_digits).first( ) which returns the matching user record or None if no match is found. In SQL terms, this executes a SELECT statement such as: SELECT*FROM user_registration WHERE digit_sequence=‘collected_digits’ LIMIT 1. The database query utilizes indexes on the digit_sequence column to ensure fast lookup performance even with large numbers of registered users.

If a matching user record is found in the video-enabled database 214, the processor 202 examines the user's preferences to determine the appropriate call routing. If the video_enabled field is set to True (indicating the user has enabled video calling) and the user's device is reachable (determined by attempting to establish connection using the device_token), the processor 202 selects video-enhanced mode. If the video_enabled field is set to False, or if the device 212 is offline or unreachable, the processor 202 selects PSTN fallback mode and routes the call to the phone number stored in the user's fallback_number field. This decision logic ensures that calls are always completed using the best available method.

If no matching record is found in the video-enabled database 214 (i.e., the collected digit sequence does not correspond to any registered user), the processor 202 automatically selects PSTN fallback mode. In this mode, the apparatus 104 routes the call through traditional telephone networks using the collected digit sequence as the destination phone number. This ensures backward compatibility with the pre-existing communication system, allowing calls to non-registered users to be completed normally through the existing PSTN infrastructure without requiring all users to register for video capability.

Users register for video-enhanced communication by downloading a mobile application and completing a registration process. During registration, the mobile application communicates with the Django backend 224 via RESTful API endpoints (typically using HTTPS for secure communication). The registration process includes: (a) user authentication (such as username/password, SMS verification, or single sign-on); (b) assignment or selection of a digit sequence that will be used to reach the user; (c) collection of the device token for push notifications; (d) configuration of user preferences including whether video calling should be enabled by default; and (e) optional entry of a fallback phone number for PSTN routing when video is unavailable.

The mobile application communicates with the Django backend 224 to update user preferences and retrieve call notifications. When the apparatus 104 initiates a video-enhanced call, the Django backend 224 sends a push notification to the user's mobile device 212 using the stored device_token. The push notification contains call metadata including the caller's identifier, timestamp, and connection parameters for retrieving the audio and video stream from the media server 220. The mobile application, upon receiving the push notification, displays an incoming call interface to the user and, if the user accepts the call, establishes a connection to the media server 220 to retrieve the composite audio and video stream.

The video-enabled database 214 is remotely updateable by registered users through the mobile application. Users can modify their preferences at any time, including: (a) enabling or disabling video calling; (b) updating their fallback phone number; (c) changing their assigned digit sequence (subject to availability); (d) updating device tokens when installing the application on a new device; and (e) temporarily forwarding calls to alternative numbers. These updates are transmitted from the mobile application to the Django backend 224 via API calls, which validate the changes and update the corresponding database records. The changes take effect immediately for subsequent calls, allowing users to dynamically control their video calling preferences.

The Django backend 224 provides administrative interfaces (Django Admin) that allow system administrators to: (a) view and manage user registrations; (b) monitor database performance and query statistics; (c) configure system-wide settings such as default preferences and routing policies; (d) view call logs and analytics; and (e) perform database maintenance operations such as backups and schema migrations. The administrative interface is accessible through a web browser and includes role-based access controls to ensure that only authorized personnel can modify system configurations.

For scalability and reliability, the database 214 may be deployed in a high-availability configuration with primary and replica servers. PostgreSQL supports streaming replication, allowing data to be continuously replicated from a primary server to one or more replica servers. In the event of primary server failure, a replica can be promoted to become the new primary, minimizing downtime. The Django application can be configured to route read queries to replica servers and write queries to the primary server, distributing database load and improving performance. Alternative embodiments may use database clustering, sharding, or cloud-based database services such as Amazon RDS, Google Cloud SQL, or Azure Database for PostgreSQL to achieve similar scalability and reliability goals.

The database 214 stores call history logs for auditing, analytics, and troubleshooting purposes. Each call generates a log record containing: (a) timestamp of call initiation; (b) collected digit sequence; (c) routing decision (video-enhanced or PSTN fallback); (d) call duration; (e) recipient device information; (f) media quality metrics such as packet loss, jitter, and bitrate; and (g) any errors or exceptional conditions encountered. These logs can be analyzed to identify trends, optimize system performance, and provide usage reports to system administrators.

Security measures are implemented to protect the video-enabled database 214 from unauthorized access. The Django framework provides built-in protection against common web vulnerabilities including SQL injection (through parameterized queries in the ORM), cross-site scripting (through automatic HTML escaping), and cross-site request forgery (through CSRF tokens). Communication between the mobile application and the Django backend 224 is encrypted using Transport Layer Security/Secure Sockets Layer (TLS/SSL) (HTTPS). Database credentials are stored securely using environment variables or secrets management systems rather than being hardcoded in application code. User passwords are hashed using strong cryptographic algorithms such as PBKDF2, bcrypt, or Argon2 before storage in the database.

In yet another embodiment, the apparatus 104 may be deployed in a distributed configuration with multiple units sharing access to the same video-enabled database 214 and media server infrastructure, suitable for multi-building campuses or enterprise deployments.

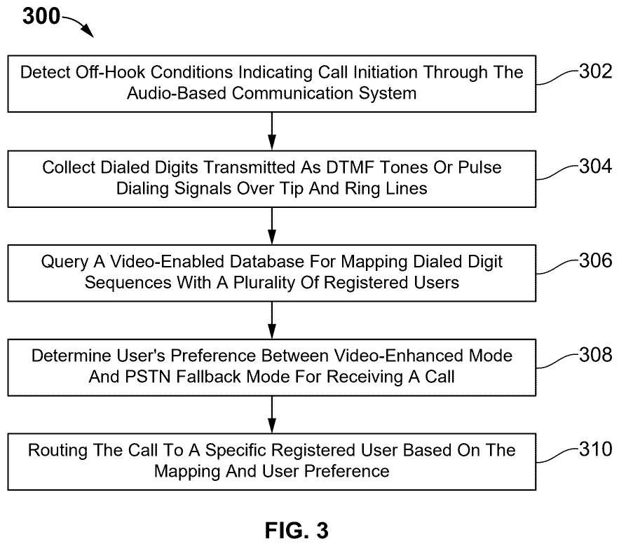

Referring to FIG. 3, a flow diagram 300 for digit collection and call routing comprises a plurality of steps.

At step 302, the telephone adapter 206 is configured to monitor the tip and ring line 112 to detect an off-hook condition. The off-hook condition is indicative of a call initiation. Call is initiated by a user of the audio-based communication system 102 by dialling digits through the audio-based communication system. The audio-based communication system 102 is configured to transmit the dialled digits over the tip and ring line 112.

At step 304, the telephone adapter 206 is configured to collect the dialled digits over the tip and ring line 112, upon detecting the call initiation. The dialled digits are transmitted as at least one of, DTMF tones, and pulse dialling signals.

At step 306, the processor 212 communicably coupled with the telephone adapter 206, is configured to query the video-enabled database 214 in order to identify video-enabled destinations for the call routing, based on the collected digits of the telephone adapter 206. The video-enabled database 214 comprising a mapping of dialled digit sequences to a plurality of receivers who have registered for video-enhanced communication. At least one desired receiver from the plurality of receivers is identified by the processor 212 based on the mapping, in order to route a call.

At step 308, the processor 202 is configured to determine preference of a registered user between a video-enhanced mode and a PSTN fallback mode for receiving a call, when a match is found for a video-enabled destination. Preference of a registered user is indicating whether video calling is enabled, device availability and capabilities of the user's receiving device, and network connectivity. In video-enhanced mode, the desired user receives a video stream along with an audio. However, in PSTN fallback mode, the processor 202 routes a call though traditional telephone network.

At step 310, the processor 202 is configured to route the call to the specific registered user based on the mapping and the preference of a registered user. The processor 202 is configured to route the call according to the registered user's preference, when the match is found for the video-enabled destination. Further, in an embodiment, the processor 202 is configured to route the call via PSTN fallback mode, when no match is found in the video-enabled database.

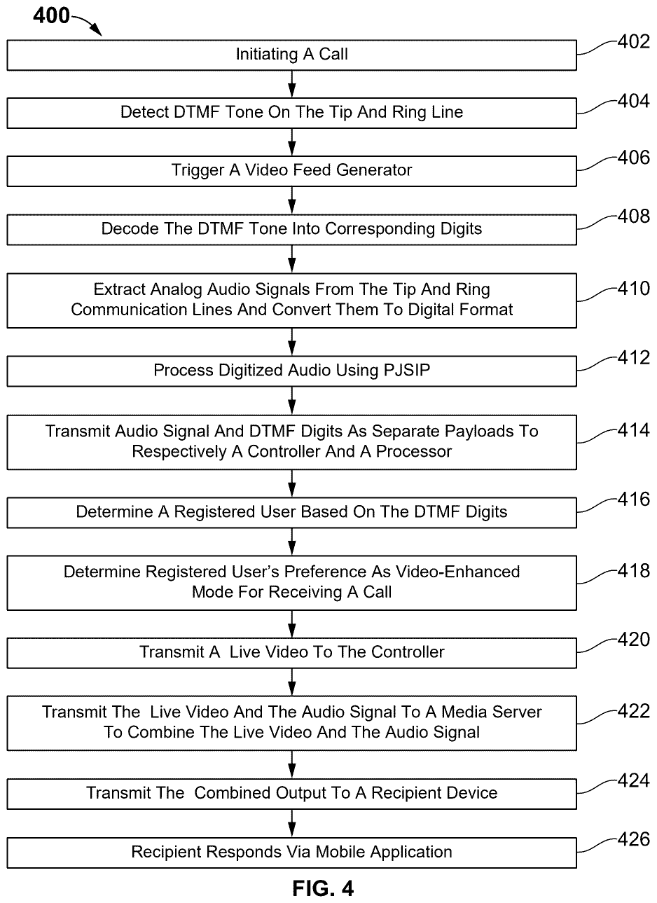

Referring to FIG. 4, a video-enhanced call flow 400 from caller to recipient device 212 comprises a plurality of steps.

At step 402, a call is initiated through the existing audio-only communication system 102.

At step 404, the telephone adapter 206 is configured to detect DTMF tone on the tip and ring line. Alternatively, the telephone adapter 206 is configured to detect pulse dialing signals. The telephone adapter 206 passively interfaces with a tip and ring line 112 of the audio-based communication system 102, monitors the tip and ring line 112 to detect call initiation signals.

At step 406, the processor 202 is configured to trigger the video feed generator 208 to begin video capture upon detection of call initiation on the tip and ring lines.

At step 408, the telephone adapter 206 is configured to decode the DTMF tone into corresponding digits (0-9, *, #, or A-D) to pass the digit to the processor 202 for accumulation into the complete dialed digit sequence.

At step 410, the telephone adapter 206 comprises an audio interface is configured to extract analog audio signals from the tip and ring line 112 and convert them to digital format suitable for transmission to the media server 220.

At step 412, the telephone adapter 206 is configured to process digitized audio using PJSIP (PJSUA2 API), an open-source SIP and media stack that handles: (a) audio codec negotiation supporting G.711, G.722, Opus, and other standard codecs; (b) RTP packet formatting and transmission according to RFC 3550; (c) jitter buffering and packet loss concealment; (d) echo cancellation and noise suppression; and (e) media stream routing to the media server.

At step 414, the telephone adapter 206 is configured to transmit the digitized audio signal and the DTMF digits as separate payloads to the controller 204 and the processor 202, respectively.

At step 416, the processor 202 is configured to determine a registered user based on the DTMF digits. The processor 202 is configured to query the video-enabled database 214 to map the DTMF digits with registered users.

At step 418, the processor 202 is configured to determine registered user's preference as video-enhanced mode to receive a call.

A step 420, the video feed generator 208, is configured to transmit a live video to the controller 204.

At step 422, the controller 204 is configured to transmit the live video and the audio signal to the media server 220 to combine the live video and the audio signal.

At step 424, the media server 220, transmits the combined output to a recipient device 212 located remotely relative to the audio-only communication system 102.

At step 426, the recipient responds via a mobile application. The telephone adapter 206 is configured to receive audio response from the recipient device 212. Further, the telephone adapter 206 is configured to transmit the audio response over the tip and ring line 112 to the communication system 102. Further, telephone adapter 206 is configured to receive a control command from the receiving device, and generate a control signal comprising at least one of: a DTMF tone sequence, an audio tone pattern, and a DC voltage pulse. Further, telephone adapter 206 is configured to transmit the control signal over the tip and ring line 112 to the communication system 102.

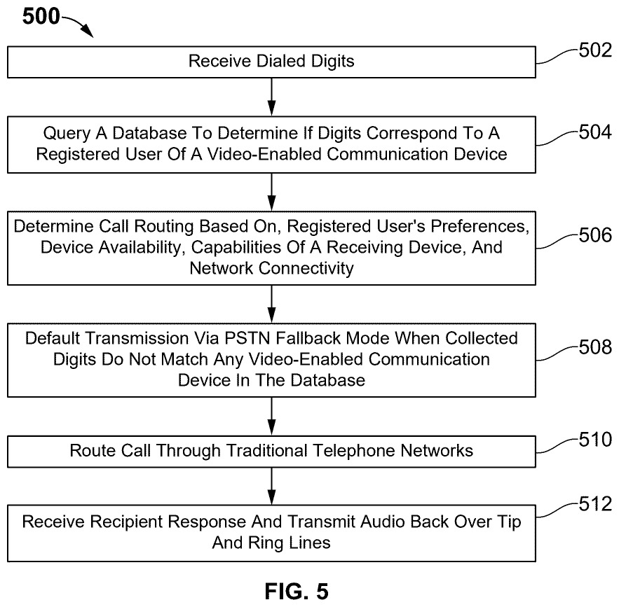

### Referring to FIG. 5, a PSTN Fallback Call Flow 500 Comprises a Plurality of Steps.

At step 502, the processor 202 is configured to receive dialled digits corresponding to DTMF tones from the telephone adapter 206.

At step 504, the processor 202 is configured to query the video-enabled database 214 to determine if the dialled digits correspond to a registered user of a video-enabled communication device.

At step 506, if the collected digits match a video-enabled destination in the video-enabled database 214, the processor 202 determines call routing based on at least one of: the matched registered user's preferences indicating whether video calling is enabled, device availability and capabilities of the user's receiving device, and current system status including network connectivity.

At step 508, if the collected digits do not match any video-enabled destination in the video-enabled database, the processor 202 defaults to the PSTN fallback mode and route the call through traditional telephone networks. This ensures that calls to non-registered users can still be completed using the tip and ring system's own directory and routing mechanisms. The telephone adapter 206 comprises an audio interface configured to extract analog audio signals from the tip and ring communication lines and convert them to digital format suitable for transmission to the media server 220 to eventually transmit to a recipient device 212.

At step 510, in PSTN fallback mode, the apparatus 104 is configured to route the call through a PSTN gateway or SIP trunk to reach the recipient's telephone number as a standard voice call. The PSTN mode is activated when at least one of, the collected digits do not match a video-enabled destination, the registered user has disabled video calling, the user's device is offline or unreachable, and network conditions prevent video transmission.

At step 512, in the PSTN fallback mode, the apparatus 104 is configured to receive recipient response over the tip and ring line 112, and transmit an audio back over the tip and ring line 112.

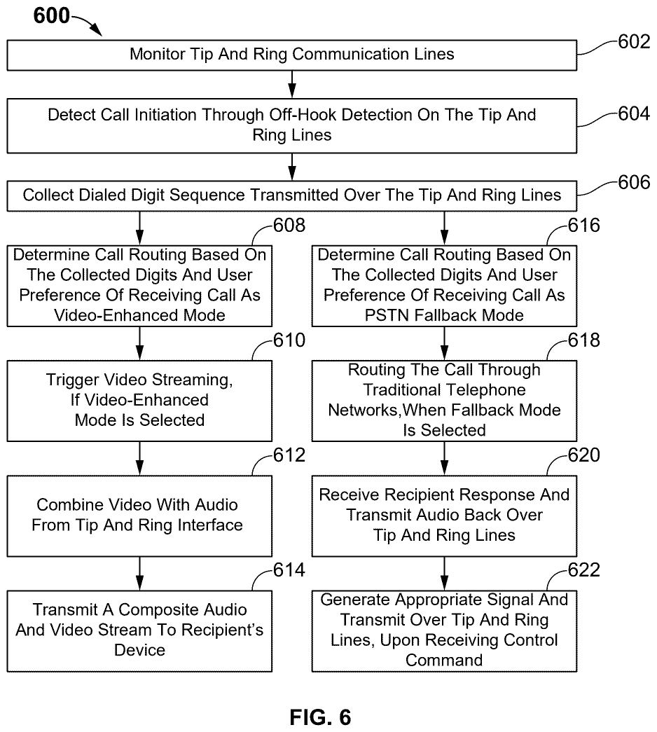

Referring to FIG. 6, a method 600 for providing video-enhanced communication comprises a plurality of steps.

At step 602, the method 600 involves monitoring the tip and ring 112 communication line.

At step 604, the method 600 involves detecting a call initiation through off-hook detection on the tip and ring line 112.

At step 606, the method 600 involves collecting dialled digit sequence transmitted over the tip and ring line 112.

At step 608, the method 600 involves determining call routing based on the collected digits and user preferences of receiving call as video-enhanced mode.

At step 610, the method 600 involves triggering video streaming, when video-enhanced mode is selected.

At step 612, the method 600 involves combining video with audio from the tip and ring interface, when video-enhanced mode is selected.

At step 614, the method 600 involves transmitting a composite audio and video stream to the recipient's device 212, when video-enhanced mode is selected.

At step 616, the method 600 involves determining call routing based on the collected digits and user preferences of receiving call as PSTN fallback mode.

At step 618, the method 600 further involves routing the call through traditional telephone networks, when PSTN fallback mode is selected.

At step 620, the method 600 further involves receiving recipient response and transmitting audio back over the tip and ring lines, when PSTN fallback mode is selected.

At step 622, the method 600 further involves generating appropriate signal and transmitting over the tip and ring line 112 upon receiving a control command, when PSTN fallback mode is selected.

1. An apparatus for augmenting a pre-existing tip and ring-based audio-only communication
system with video capability, the apparatus comprising:
a telephone adapter configured to:
passively interface with a tip and ring communication line of the pre-existing audio-only communication system;
monitor the tip and ring communication line without initiating calls on the pre-existing communication system;
detect a call initiation signal generated by the pre-existing communication system; and
collect a dialed digit sequence transmitted over the tip and ring line by the pre-existing communication system;
a video-enabled database that is separate from and independent of any directory maintained by the pre-existing communication system, wherein the video-enabled database stores mappings between a plurality of dialed digit sequences and users who have registered for video-enhanced communication through a receiving device;
a processor configured to:
query the video-enabled database using the collected dialed digit sequence;
when a match is found for a registered user, determine call routing based on the registered user's preferences between video-enhanced mode and PSTN fallback mode; and
when no match is found, automatically select PSTN fallback mode;
a video feed generator configured to stream live video when video-enhanced mode is selected;
a controller configured to, when video-enhanced mode is selected, direct audio from the tip and ring communication lines and the streaming video to a media server, wherein the media server combines the audio and video to generate a composite audio and video stream; and
a communication interface configured to:
in video-enhanced mode, enable the receiving device associated with the registered user to connect to the media server and retrieve the composite audio and video stream; and
in PSTN fallback mode, route the call through a PSTN network,
wherein the apparatus augments the pre-existing communication system by adding video capability without replacing or modifying the pre-existing communication system, and wherein the pre-existing communication system continues to operate for audio-only calls independently of the apparatus.

2. The apparatus of claim 1, wherein the telephone adapter is configured to collect the dialed digit sequence by detecting DTMF tones or pulse dialing signals transmitted over the tip and ring lines.

3. The apparatus of claim 1, wherein the processor selects PSTN fallback mode when at least one of: the collected digit sequence does not match any video-enabled destination in the video-enabled database, the receiving device has video calling disabled, the receiving device is offline or unreachable, and network conditions prevent video transmission.

4. The apparatus of claim 1, wherein the telephone adapter is further configured to:
receive audio response from the receiving device; and
transmit the audio response over the tip and ring lines to the communication system.

5. The apparatus of claim 1, wherein the telephone adapter is further configured to:
receive a control command from the receiving device;
generate a control signal comprising at least one of: a DTMF tone sequence, an audio tone pattern, and a DC voltage pulse; and
transmit the control signal over the tip and ring lines to the communication system.

6. The apparatus of claim 1, wherein the apparatus is configured to access a video-enabled database of video-enabled destinations, wherein the database maps dialed digit sequences to users who is using the receiving device and registered for video-enhanced communication, wherein the database is remotely updateable by the registered users through the receiving device.

7. The apparatus of claim 6, wherein the processor is configured to:
query the video-enabled database using the collected digit sequence;
route the call according to the registered user's preferences, when a match is found for a video-enabled destination; and
route the call via PSTN fallback mode, when no match is found in the video-enabled database.

8. The apparatus of claim 1, wherein the video feed generator is triggered to begin video streaming upon detection of call initiation on the tip and ring lines.

9. The apparatus of claim 1, wherein the controller directs the audio and video streams to the media server, and wherein the media server combines the audio and video streams to generate the composite audio and video stream for retrieval by the receiving device.

10. The apparatus of claim 1, wherein the video feed generator is configured to encode the video stream using at least one codec selected from the group consisting of: H.264, H.265, VP8, VP9, and AV1.

11. The apparatus of claim 1, wherein the media server is configured to encode audio using at least one codec selected from the group consisting of: Opus, G.711, G.722, and AAC.

12. The apparatus of claim 1, further comprising a history log database for storing call events, collected digit sequences, video feeds, and control commands.

13. The apparatus of claim 1, wherein the video feed generator comprises multiple cameras positioned at different viewing angles, and wherein the receiving device is enabled to select between video streams from the multiple cameras.

14. A method for providing video-enhanced communication for a tip and ring-based communication system, the method comprising:
interfacing with tip and ring communication lines;
detecting call initiation on the tip and ring lines;
collecting a dialed digit sequence transmitted over the tip and ring lines;
determining call routing based on the collected digit sequence, wherein the call routing comprises selection between video-enhanced mode and PSTN fallback mode;
when video-enhanced mode is selected:
streaming of live video;
combining audio from the tip and ring interface with the video to generate composite audio and video stream; and
transmitting the composite audio and video stream to a receiving device; and
routing the call through a PSTN network, when PSTN fallback mode is selected.

15. The method of claim 14, further comprising:
receiving an audio response from the receiving device; and
transmitting the audio response over the tip and ring lines to the communication system.

16. The method of claim 14, further comprising:
receiving a control command from the receiving device;
generating a control signal comprising at least one of: a DTMF tone sequence, an audio tone pattern, and a DC voltage pulse; and
transmitting the control signal over the tip and ring lines to the communication system.

17. The method of claim 14, wherein collecting the dialed digit sequence comprises detecting at least one of: DTMF tones and pulse dialing signals transmitted over the tip and ring lines.

18. The method of claim 14, wherein determining call routing comprises selecting PSTN fallback mode when at least one of: the receiving device has video calling disabled, the receiving device is offline or unreachable, or network conditions prevent video transmission.

19. The apparatus of claim 1, wherein the telephone adapter comprises an audio interface using PJSIP for audio processing, wherein the PJSIP stack is configured to: encode digitized audio from the tip and ring lines using a codec selected from the group consisting of: Opus, G.711, and G.722; encapsulate the encoded audio into RTP packets; and transmit the RTP packets to the media server.

20. The apparatus of claim 19, wherein the audio interface comprises a codec integrated circuit configured to: perform analog-to-digital conversion of audio signals from the tip and ring lines at a sampling rate of 8kHz, 16kHz, or 48kHz; and perform digital-to-analog conversion of return audio from the receiving device for transmission over the tip and ring lines.

21. The apparatus of claim 19, wherein the PJSIP stack is configured to detect the DTMF tones in the audio from the tip and ring lines and decode the DTMF tones into corresponding digits for the dialed digit sequence.

22. The apparatus of claim 1, wherein the telephone adapter provides impedance matching of approximately 600 ohms to match standard telephone line impedance characteristics.
